(19) United States
(12) Patent Application Publication
(10) Pub. No.: US 2011/0320340 A1
(43) Pub. Date: Dec. 29, 2011

(54) System and Method for Data Collection, Storage and Analysis For Use in Managing Risk Associated with Lending Portfolio Assets

(76) Inventors: Stephen E. Falconer, Derry, NH (US); Paul Falconer, Plymouth, MA (US)

(21) Appl. No.: 12/419,067

(22) Filed: Apr. 6, 2009

Related U.S. Application Data
(60) Provisional application No. 61/042,367, filed on Apr. 4, 2008.

(51) Int. Cl. G06Q 40/00

(52) U.S. Cl. 705/38

(57) ABSTRACT

A computer-assisted, automated method and system for combining loan and asset data in a data warehouse, which provides an early warning system for potential risks and a facility for portfolio and market analysis. The system provides online access, data manipulation, analytical capabilities and report production. The system continuously monitors the lender's data versus thresholds in order to provide alerts. The system selects data on a regular basis, calculates market indices and creates additional data values based on these calculated indices. The market indices are stored in an aggregated data area and are available to user's system-wide.

### CROSS-REFERENCE TO RELATED APPLICATIONS

This application claims the benefit of U.S. Provisional patent application No. 61/042,367 filed Apr. 4, 2008 and incorporated fully herein by reference.

### TECHNICAL FIELD

The present invention relates generally to automated data collection and analysis and, more particularly, to a system and method for managing risk in portfolios of lending institutions.

### BACKGROUND INFORMATION

Risk management practices for lending based on real estate collateral can be a labor-intensive endeavor. A single loan file may contain many different documents related to the terms of a loan, including, for example, security instruments, memoranda, appraisals and the like. Loan officers, underwriters, asset managers or other personnel on the lender's staff frequently receive and capture data from these documents and report this data for a wide variety of uses in the course of originating, servicing and evaluating loans. Collateral and borrowers may be involved in multiple loans. The staff additionally has to determine ratios of assets to capital and determine risk profiles in order to satisfy regulatory requirements and provide management with appropriate levels of information in order to effectively run the business.

Based on a guidance document published in December of 2006, federal regulators are requiring banks to exercise stress tests and commercial real estate concentration reporting. However, all of the influences on real estate collateral values are dynamic. The final layers of influence are local market conditions. All of these factors are an important part of a bank's or lending institution's risk management.

In the past, the focus on lending has been borrower credit worthiness and cash flow produced from the loan. Until recent times, the collateral was evaluated as a static valuation at the time of loan creation or rewrite. Computerized loan systems developed for banks therefore focused only on cash flow tracking and borrower credit worthiness. No systems exist which include tracking of the collateral asset value in concert with the influences on it with its use and location, over time.

“Stress testing” is an important and evolving tool in risk mitigation, and banking regulators increasingly look for its use in institutions of all sizes. Stress testing is examining an alternative future that could cause problems in a lending institution's portfolio. It enables the lending institution to determine how bad those problems could become and prepare for them should that scenario develop. It also enables the lending institution to verify whether it would be able to handle the problems. Stress Testing also allows the institution to proactively and hypothetically “test” alternative scenarios based on what they put in their portfolio, how they manage the portfolio, how they capitalize it and what impact external events such an inflation, loss of rental income, decrease in property valuation, etc. might have on the institution's portfolio.

The Federal Reserve recently published a paper stating that over 40% of participating banks were not producing stress tests on their portfolio loans. Of those that are, a majority are doing it manually using desktop spreadsheet software. Those efforts are not only time consuming, but they are “throw away” results since once completed, the data is not valid since it is not dynamic.

The events of 2008 and 2009 in the financial services arena appear to indicate that bank supervisors will probably enforce their requirement for stress tests and other reports from the banks more strictly and may well create new reporting requirements.

Accordingly, what is needed is an automated, computer assisted system and method for combining loan and asset data in a data warehouse, which provides an early warning system for potential risks and a facility for portfolio and market analysis.

### SUMMARY

The system and method according to the present invention includes a computer-assisted method for processing asset descriptive documents in a database with loan and borrower information. The presentation layer of the system will allow an end user to display, analyze, change assumptions, stress, shock and report on the collateral components of a portfolio in relation to the entire portfolio of loans. This data warehouse of information gives the risk management team at a bank a tool for strengthening the soundness of their bank and promotes efficiencies in the oversight process as well.

Each system participant has a secure environment with their data available electronically from summary levels to a detailed level. The system will independently process data in the data warehouse in order to calculate current market indices. This aggregated data has two purposes within the design. First, the indices can be called into graphic presentations in order to indicate trend information by market. Secondly, the indices are used in further processing in order to produce a current Indicated Investment Value for any given property in the database. Those values are the base values for a section of the Early Warning System features.

The system and methods designed provide an electronic data warehouse of borrower, loan and collateral asset data; provide a secure site available via the internet by any authorized employee; provide a tool to electronically create stress and shock tests of the portfolio; provide analysis capabilities including reports on loan concentration for regulators; provide a system that calculates local market real estate value indices; and provide a customizable Early Warning System based on the business needs of the individual institution.

### BRIEF DESCRIPTION OF THE DRAWINGS

These and other features and advantages of the present invention will be better understood by reading the following detailed description, taken together with the drawings wherein:

FIG. 1 is a schematic block diagram of a system on which may be implemented the present invention;

FIG. 2 is a schematic block diagram of various data sources, data storage and user access provided by the system of the present invention;

FIG. 3 is a screen shot of a user's loan portfolio in accordance with one display feature of the present invention;

FIG. 4 is a screen shot illustrating various data display methods for a property for which David is maintained in the present invention;

FIG. 5 is a screen shot of a user's alerts generated by the system in accordance with the teachings of the present;

FIG. 6 is a screen shot of a display of data on a loan which exceeds tolerance in accordance with the teachings of the present invention;

FIG. 7 is a screen shot illustrating a multiunit real estate project showing data for the various real estate units by unit number;

FIG. 8 is a screen shot of a loan officers projects as tracked in the system in accordance with the teachings of the present invention;

FIG. 9 is a detailed screen shot of one project of a loan officer in accordance with the teachings of the present invention;

FIG. 10 is a screen shot of geographic data retrieved from the data base maintained by the system in accordance with one of the teachings of the present invention;

FIG. 11 is a screen shot illustrating a lender's review of various loan officers portfolio's in accordance with one aspect of the present invention

FIG. 12 is a screen shot illustrating the system of the present invention providing information about various categories of loans of a given lender as a user of the system of the present invention;

FIG. 13 is a pie charge illustrating the current portfolio balance of outstanding loans in accordance with yet another display feature of the present invention;

FIG. 14 is a screen shot illustrating a lender's various use sectors within their loan portfolio;

FIG. 15 is a screen shots illustrating a lender's property type within a specific city or town in accordance with yet another display and reporting capability of the present convention;

FIG. 16 is a screen shot of yet another display capability of the present invention utilizing criteria selected by the user for display; and

FIG. 17 as a screen shot showing David displayed in a “dial” format in accordance with one future of the present invention.

### DETAILED DESCRIPTION OF THE PREFERRED EMBODIMENTS

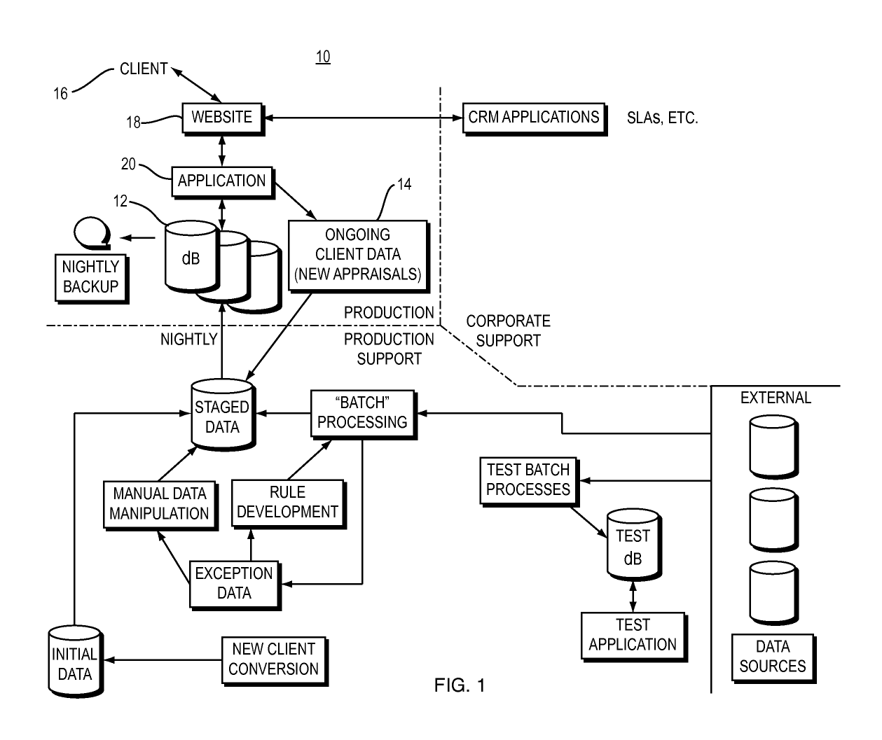

The present invention features an automated, computer implemented system and method 10, FIG. 1, for electronic storage of collateral asset value documentation and automated aggregation of market indices derived from that asset information. The method comprises associating an asset with a record in a database 12, including collecting data from the asset document independently of an end use of said document and relating the asset record to pertinent loan record. Electronic versions of support documents for asset (i.e. Appraisals 14) are also stored. Users 16 are allowed on demand access to specific information contained in the record via a provided web site 18 running an application program 20 according to the present invention. The system may generate information from a plurality of the records pursuant to analysis and reporting capabilities for subsets of the assets. Based on market data contained in the plurality of records, the system and method calculates and compiles the aggregated common information in a database and uses the aggregated data to create updated data within the original records.

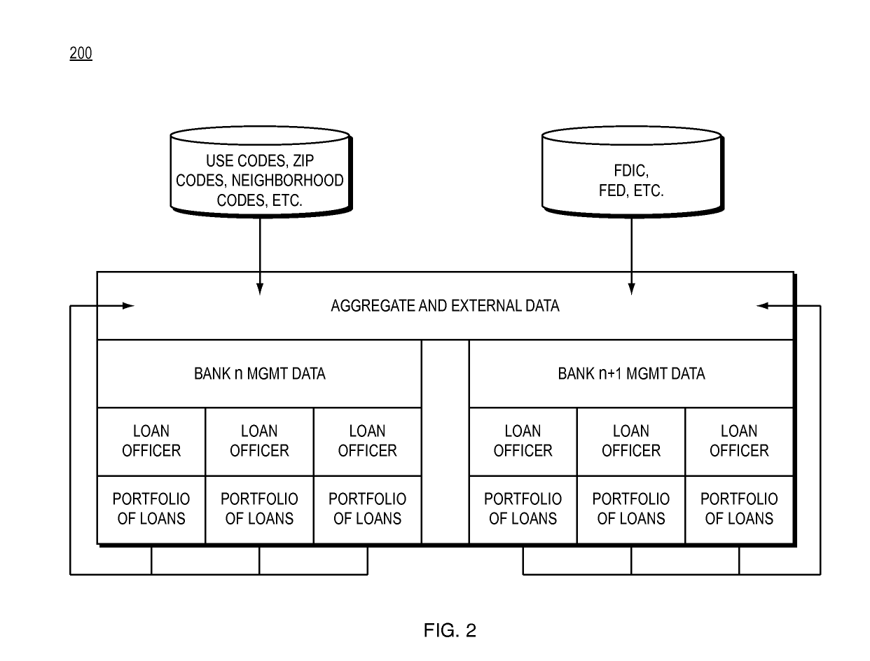

The system is comprised of multiple screens, which facilitates the entry, validation and review of data from various sources, see FIG. 2 for example, pertinent in the risk management of a lender's/loan officer's portfolio of loans. This includes information on the loan, borrower and collateral assets. The loan data may include but is not limited to terms, conditions, borrowers, amounts, dates and categorizations for regulatory reporting. The borrower information includes but is not limited to name and contact information. The asset information includes but is not limited to photograph, location identification, physical characteristics, legal ownership references and, where applicable, tenant information, income and expense information. The system additionally provides for electronic storage of related documentation (i.e., Appraisals).

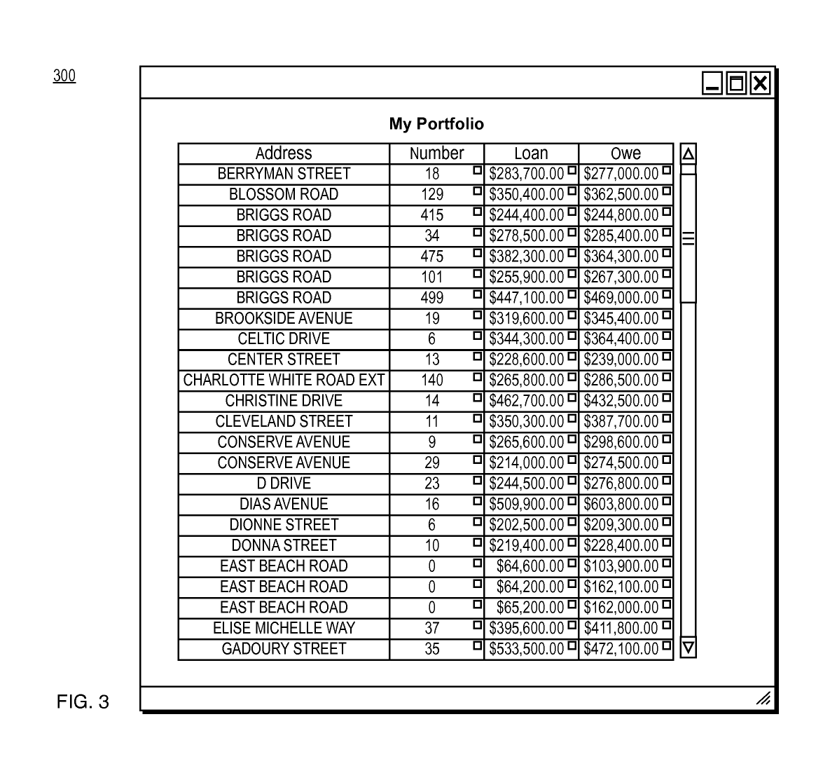

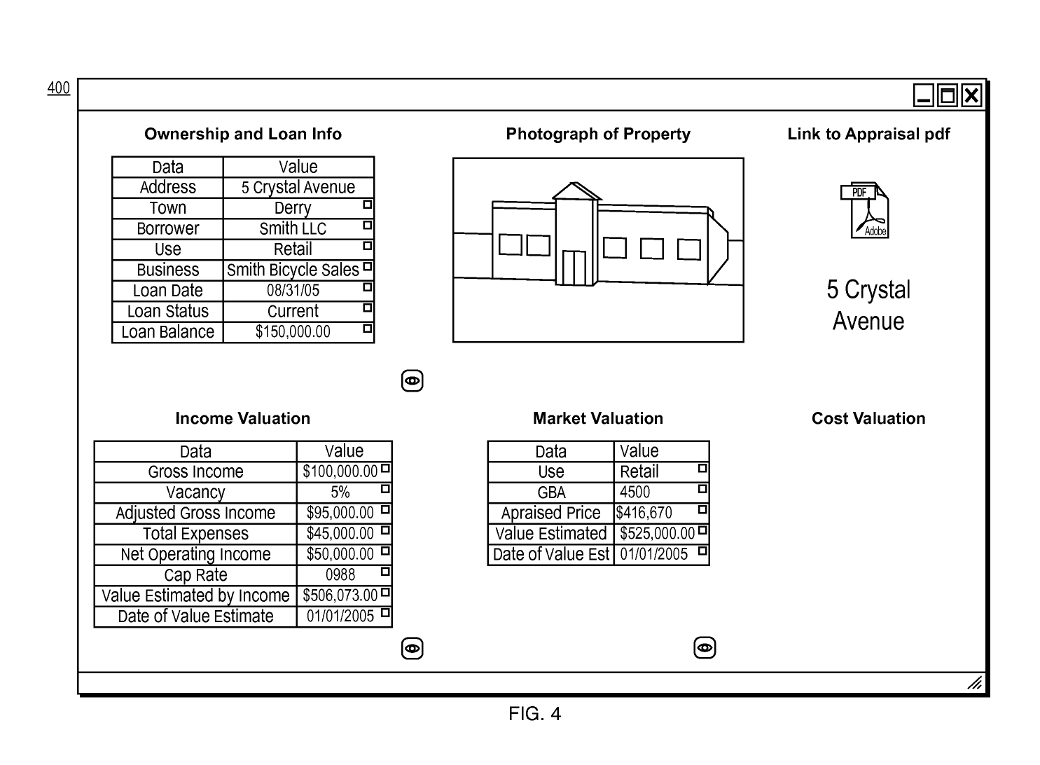

The system provides for the user to select and display selected data and other information based on a combination of the characteristics described above. See for example FIGS. 3 and 4. Once selected, the user is able to ‘drill-in’ for further and more detailed analysis. The user can request a summary view, detailed view and graphic representation of their selection. The graphic representation permits ‘drill-in’ to any data point that is based on data contained in the database. Any data points on the graph which are from the aggregate database are presented to aid trend analysis, but cannot display further layers of detail.

The system provides an aggregate database of information 200, FIG. 2, based on data calculated from all participants in the system as well as information from outside the system. These calculated data points may include, but are not limited to, rent rate, vacancy rate, absorption rate, cap rate, sales price per square foot and value per square foot. These market indices are tracked by geography, property use and date.

The system provides the capability for the client (i.e. a loan office for example) to display 300, FIG. 3, all of his or her loans in the loan officer's portfolio. The fields to be displayed are configurable and each screen that can be printed with the click of a mouse. The system can also print various reports screens as illustrated in screen 400, FIG. 4. The filters and feels to be displayed are configurable.

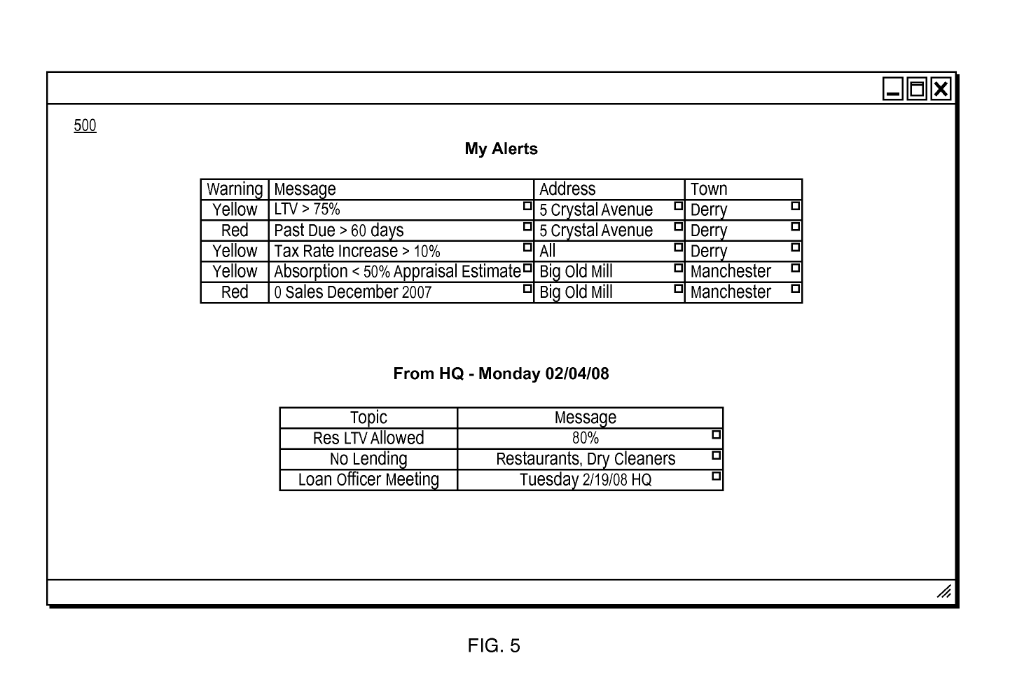

The system further provides an alert capability 500, FIGS. 5, and 600, FIG. 6, to the user/client based on thresholds defined by the client. Alerts may include, but are not limited to, Loan-To-Value (LTV) ratio, Vacancy threshold, Rental Expense ratio and Lease Out-Of-Date. Federal banking agency guidance on transaction sensitivity for lending focuses on absorption rates, sales prices, rental rates, vacancy rates, loan-to-value ratios and other varying market conditions all of which can be set as alert tolerances in the present invention. The system is designed to take specific actions based on the triggering of the alerts. The minimum alert is to change the color of the data point to red wherever it is displayed on the user's display screen. The thresholds are dynamic. An individual user in a client organization can change the level of threshold at any time in order to raise/lower the awareness of a given data condition.

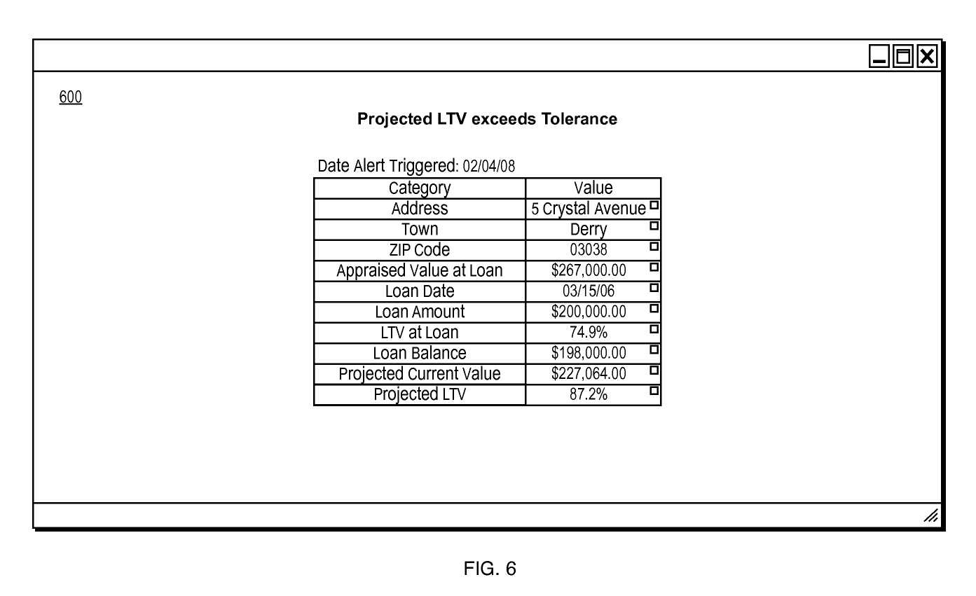

As shown in FIG. 6, the invention, which can nightly produce a projected current property value, for example, triggered an alert based on the projected loan to value (LTV) ratio. This projection is based on current market data. Since the FDIC has a concern that values reflected in the portfolio may not reflect a current market value, this information is helpful in meeting FDIC concerns and guidelines in case a property has to be liquidated.

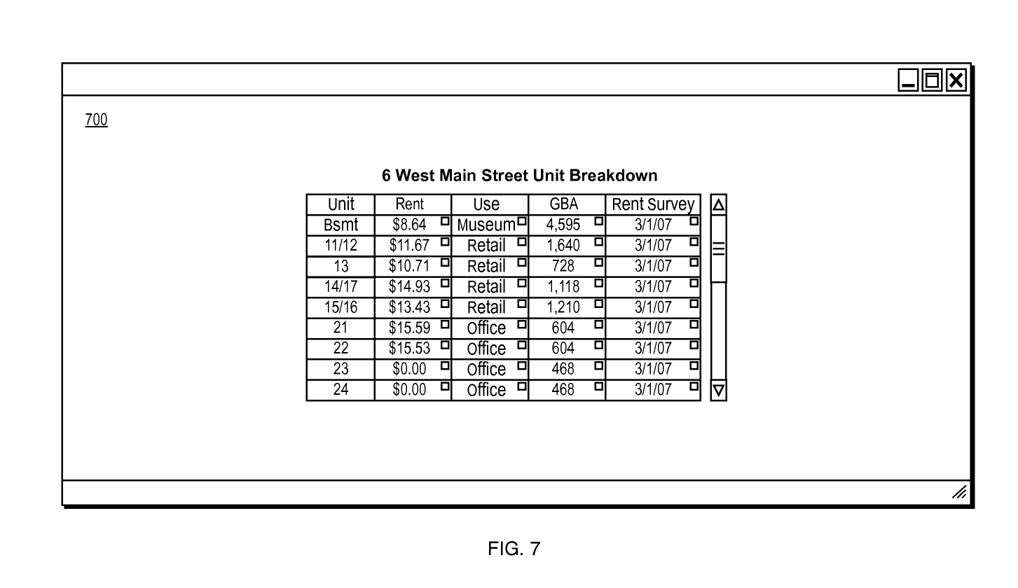

For example, a loan officer may have loans on 6 West Main Street and 999 Main Street. The actual Rent Roll at any property, such as at 6 West Main Street can be displayed as shown at 700, FIG. 7. The invention may display size of the property, rent rate and rent date from the database. Data is as current in terms of whatever has been provided to the bank or lending institution. This actual data is the type of information that becomes the aggregate data for other features in the tool.

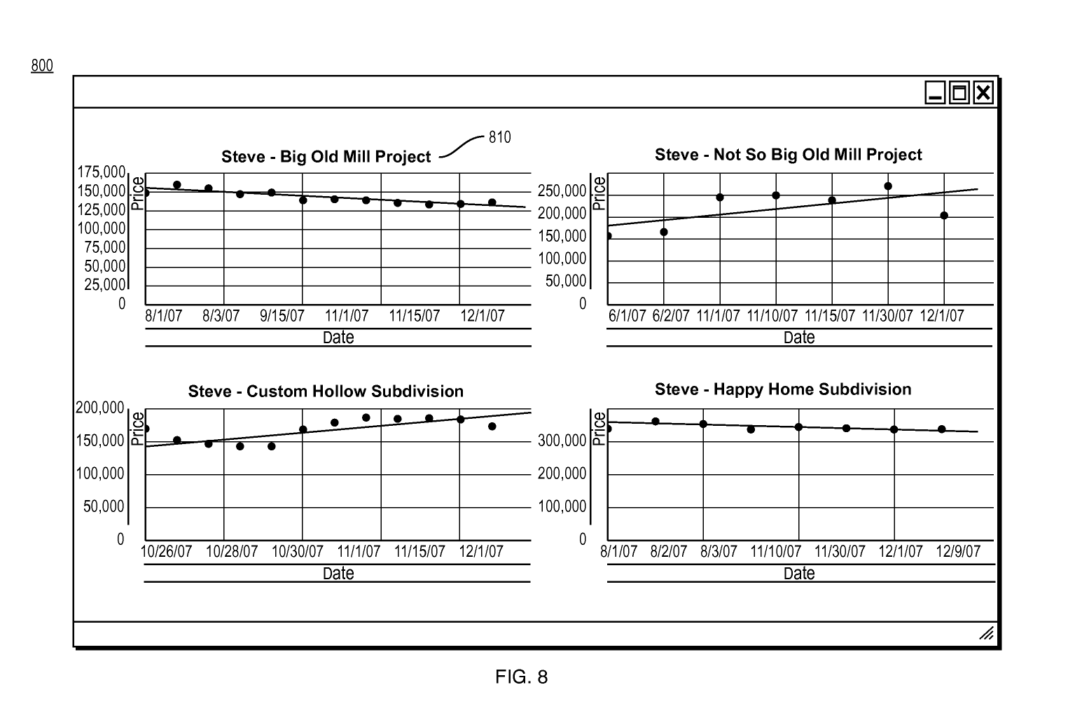

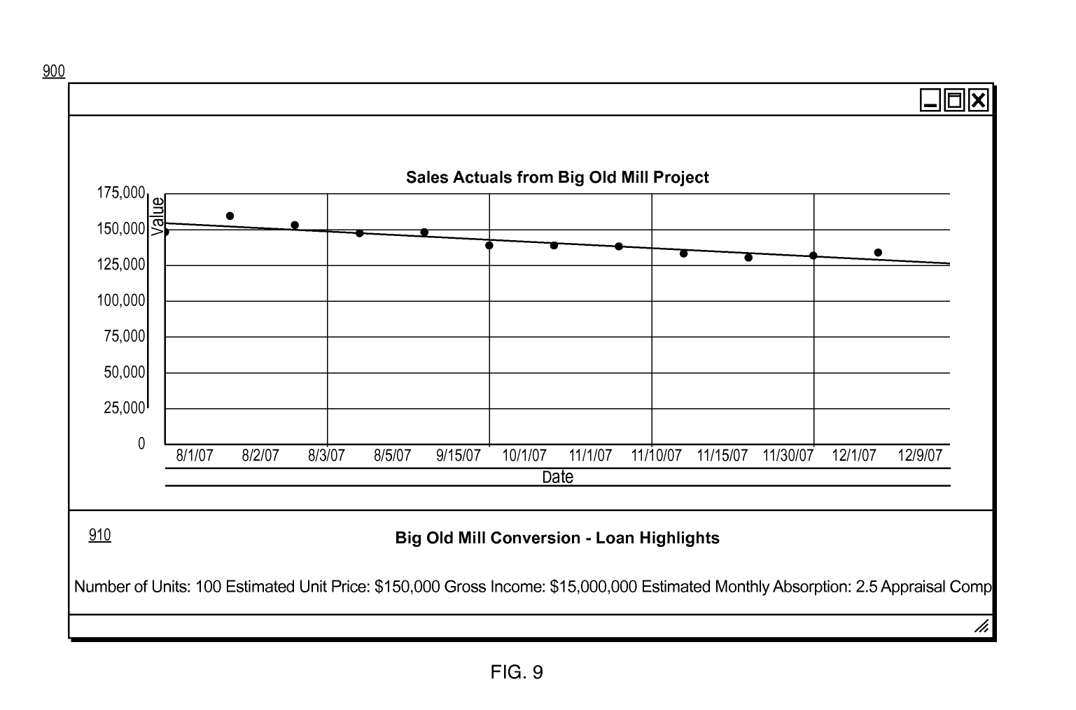

The present invention also has the capability of tracking various ongoing projects for any given loan officer. For example, as shown at 800, FIG. 8, loan officer Steve has four projects ongoing that the present invention is tracking. Greater detail as to one project, such as project 810, is shown at 900, FIG. 9. FIG. 9 illustrates that the invention provides actual sales in a graphical form while lower region 910 of this screen 900 displays the loan assumptions presented in a ticker tape style display.

Since federal supervisory insights state that “factors that contribute to CRE losses include . . . long gestation periods that allow supply-and-demand dynamics to change before a project's completion”, the present invention provides an early warning system as to those changes thus assisting a bank or other lending institution that utilizes the present invention to be in compliance with federal supervisory guidelines.

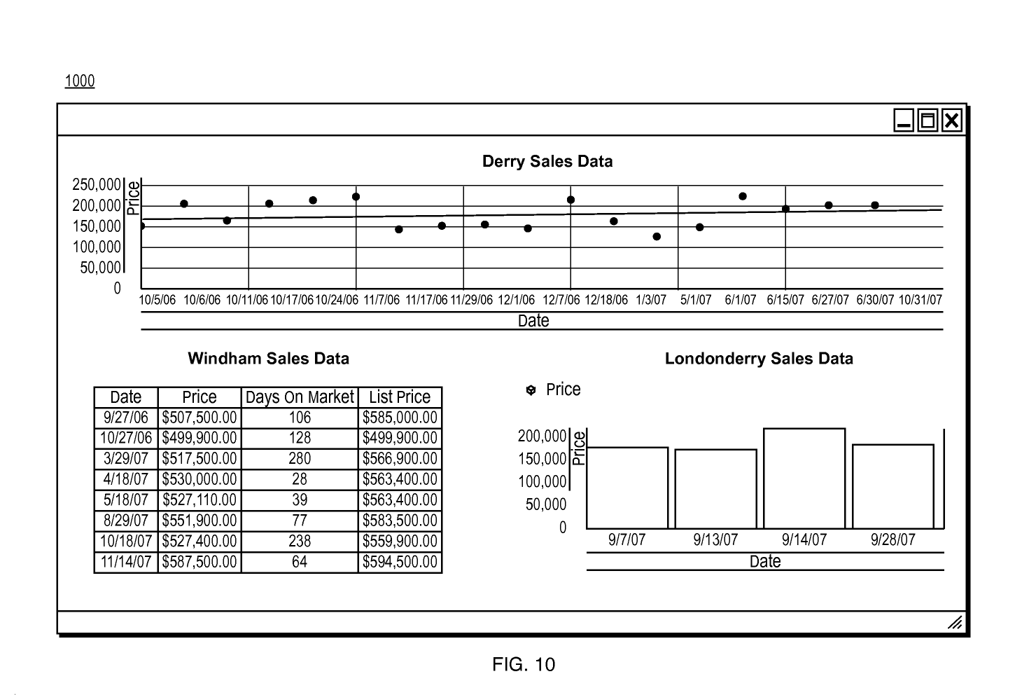

Market changes during the gestation period between Loan Closing and Project Completion is a documented concern of the FDIC and other Supervisors. The present invention can be configured to track and present market sales on a variety of levels as shown at 1000, FIG. 10.

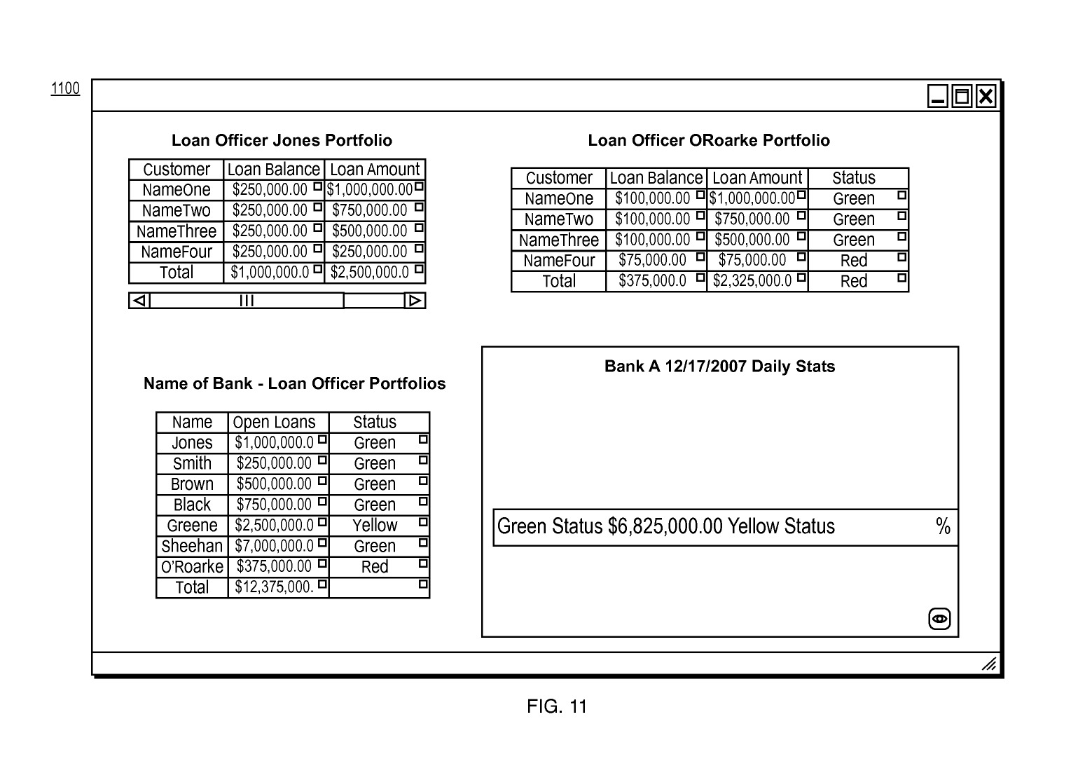

Management of a bank or other lending institution may also review their portfolio by loan officer as shown at 1100, FIG. 11. Management can see each individual loan officers portfolio as well as a collection of all loan officer portfolios with a status indicator showing whether or not a project is within tolerance, moving towards an out of tolerance condition or currently out of tolerance.

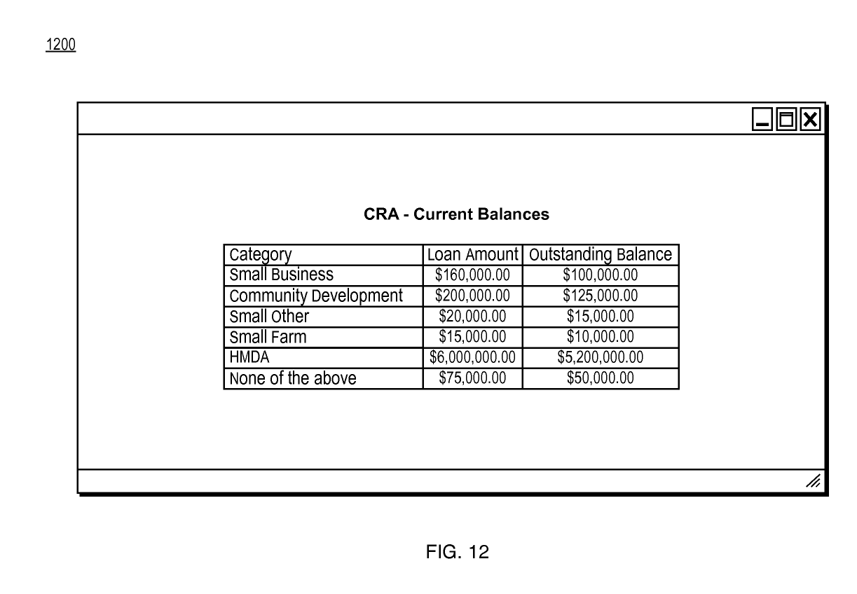

The present invention may also present summary or detailed data by loan type. For example, loans provided under the Community Reinvestment Act (CRA) my be reported by group type as shown at 1200, FIG. 12.

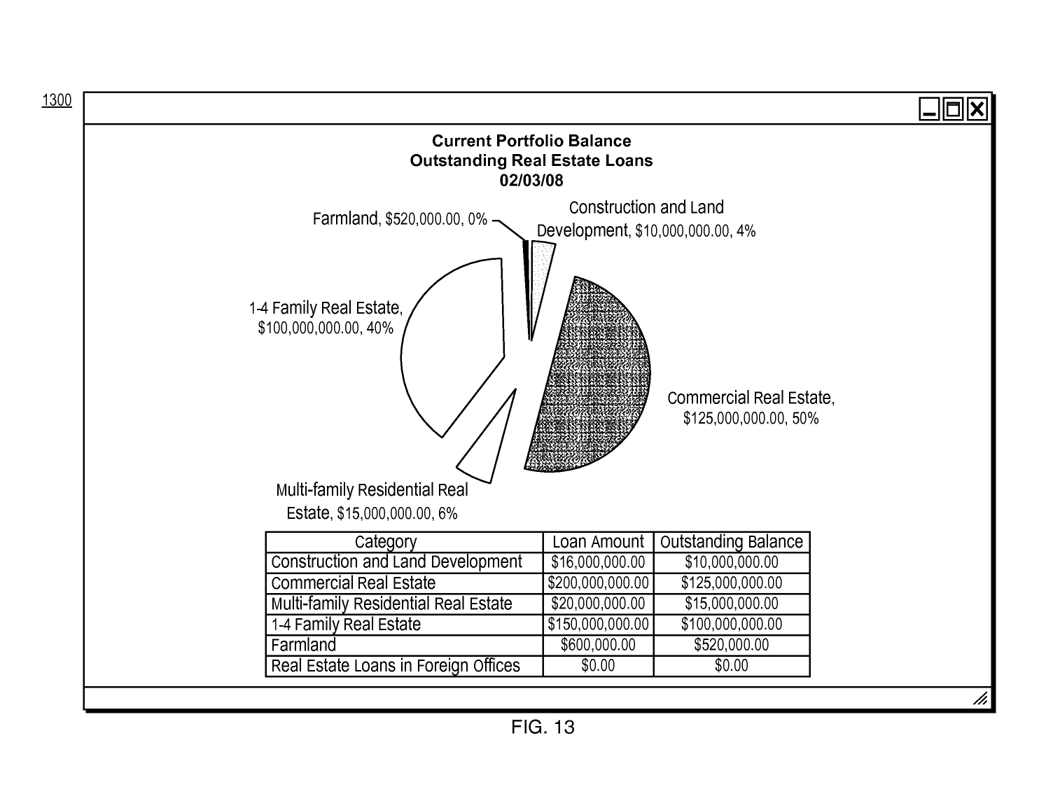

In addition to the presentation of data as described above, the present invention may also provide information concerning the portfolio of outstanding loans by loan officer, bank or the like and display such information in a pie chart as shown at 1300, FIG. 13.

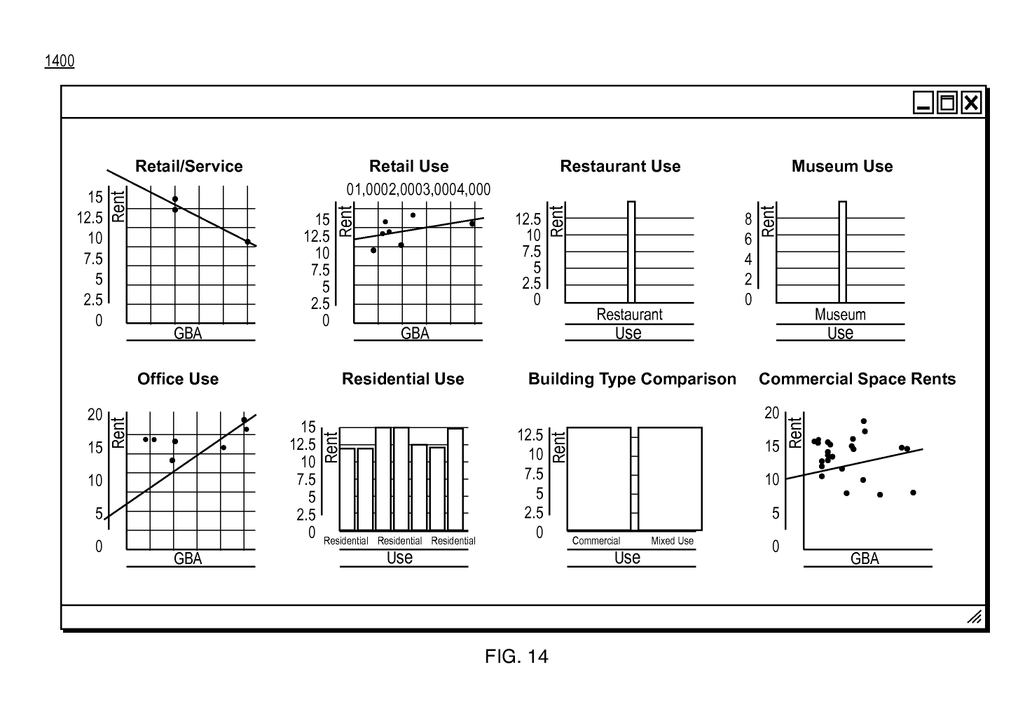

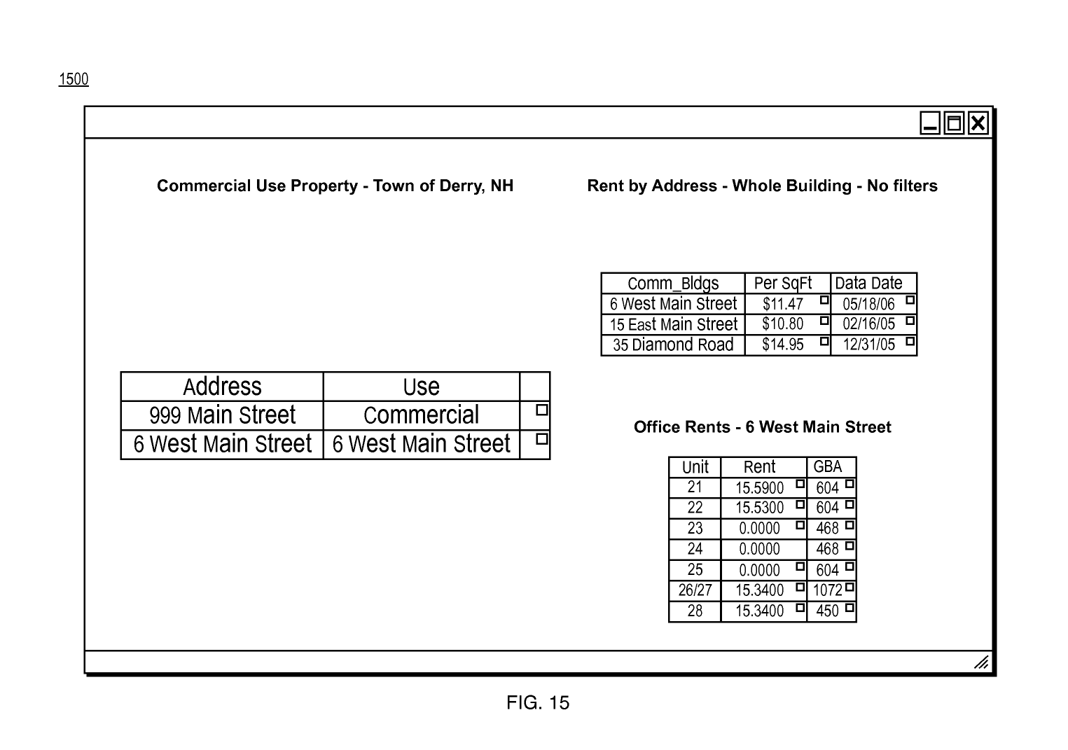

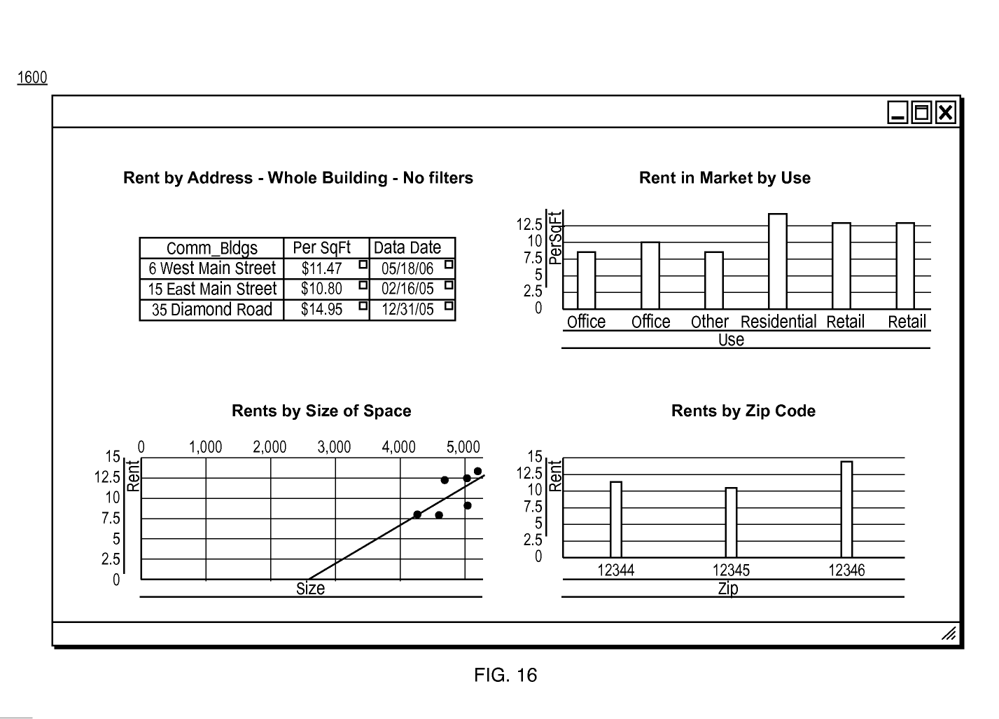

In another embodiment of a different display in accordance with the teachings of the present invention, by displaying the Community and Property—Type, a Loan Officer can review the aggregate market data while the borrower is sitting in front of him/her. The present invention can present income, Expenses and Sales data for immediate validation within the marketplace. Some views of rents for various uses are shown at 1400, FIG. 14. A loan officer can review different levels of data. For example, a loan officer can review address specific market data if his/her institution is the lender on the properties as shown at 1500, FIG. 15. When appropriate, bank specific data and aggregate (non-bank specific) data can be combined in one view. Since the user is identified by their institution through the logon process, Bank Private data and aggregated market data can be combined into one presentation screen 1600, FIG. 16. This could allow the user to compare the performance of the loaned properties versus the market as a whole.

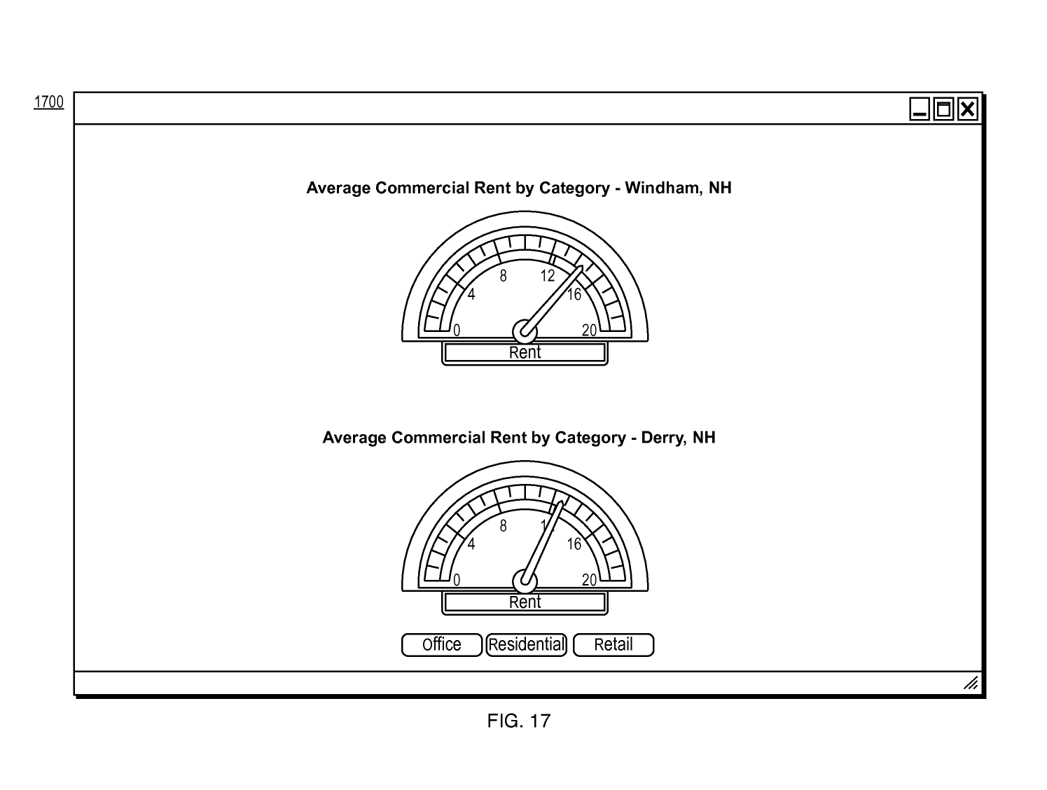

In another display process in accordance with another feature of the present invention, there is illustrated a comparison of aggregated data between different markets. The display “dials” as shown at 1700, FIG. 17, allow the user to compare commercial rents for like uses between two communities. This shows Retail rents in Windham 7% higher than neighboring Derry.

The present invention also provides the capability for the client to select a loan and process a “stress test” scenario against that loan by altering one or more parameters such as the Loan Amount, Amortization Period, Interest Rate, Rental Income, Vacancy Rate, Operating Expenses or Cap Rate from those recorded in the database. The stress test scenario can be saved for future reference.

The system provides the capability to select multiple loans from the database to stress together in one scenario. This group shock scenario tool allows the user to change factors such as the Interest Rate, Cap Rate, Vacancy Rate, Amortization Period or to put a global impact override against the selected loans. As a result, the system will calculate the total value of the selected loan collateral, pre-stress, the total value of the selected loan collateral, post-stress and the delta dollar value impact on the portfolio as a whole.

The system may provide an Indicated Investment Value of the loan collateral in the portfolio based on the indices created by the system in the aggregating process. This provides a dynamic collateral value base from which alerts can be targeted, hence providing another level of the Early Warning System for potential problems within the portfolio.

In the preferred embodiment, the present system and method is implemented using a computer software program running on appropriate computer hardware which combines and stores lender specific data along with select market information in a historical database for later analysis. The computer software can be run on a user's or institution's computer or server or alternatively, may be provided as a non-downloadable application located on a web site by access to a predetermined web address on the world wide web.

The data collected by or input into the software program is reviewed by the software on a regular basis against generic and client defined tolerances. Data presentation is in a dashboard format which allows the user to navigate by clicking on the data of interest. Data which is outside of the defined tolerances will be flagged by causing an alert and categorized and displayed as yellow (data requiring attention) or red (warning data). Data within range will be categorized and displayed as green (normal).

Application security is user-ID and password protected. Data security is based on the users' organization as well as their authorization level within their organization. Data will be viewable at an individual level, organizational level or aggregate market level.

The key data is loan data provided from the lender's appraisal process. This data is market verified by state licensed or certified appraisers. The data collection and reporting processes are standardized, and appraisers are bound to adhere to the uniform standards of professional appraisal practice. All appraisals created for lending in a federally related transaction are required to be produced based on the standards. By having the key data in the database come from the lender's loan documentation and appraisals, the quality of the data is extremely high. It is superior to data from sources whose licensure is not dependent on the quality of the data reported (for example, from multiple real estate listing service records). When combined with market data, the software will monitor the performance of the collateral versus those assumptions made during the appraisal process at the time the loan was created. Collateral value projections that fall outside of the lender defined tolerances will automatically be flagged for review.

Having data from highly reliable sources, including ongoing lending activity, in the database, supports a loan officer's evaluation of a new proposal from his or her desktop in real time. Market data will be available for the entire lender geography from any user desktop. Trending of asset performance, market indices, and lender performance will be available. The lender will be able to review absorption rates, vacancy rates, rental rates or other parameters that are coming in from the market continuously, based on newly created appraisals.

It is expected that the full deployment of the system and method of the present invention including the resulting database will empower the lending institutions to get a strong indication of the current market value of their portfolio on a day to day basis and receive an early indication of loans that may require attention and potentially avoid loans failing by proactively managing the borrower and the asset's exposure.

With this powerful tool in the organization, a lender will be able to tighten their risk exposure by practically and proactively addressing ongoing loans and making effective quantitative evaluation of lending proposals early in the lending process. With documented, higher-quality lending decisions and the state-of-the-art asset value management processes, it is expected that a case can be made for review and a lowering of reserve requirements. This could potentially lead to more cash available in the lending institution to put to work.

The present invention is based on high quality data as described herein. The primary functionality features include New Project Analysis—Loan offers are continually presented with proposals for evaluation. The present invention utilizes the graphical interface to present pertinent market information at a glance. This data may include vacancy rates, rental rates, absorption rates and market sales which can be trended by location and property type. A quantified response can be made immediately to the client market assumptions presented in the borrower's request.

The Sentinel—This is the monitoring process that is happening continually with the user's data as new information is added. New appraisals being entered will cause an update to existing vacancy rates, rental rates, absorption rates, market sales and other key data. The Sentinel will compare the updated information to the user's active loan collateral and flag an alert or warning to the loan officer's dashboard based on user defined tolerances. The Sentinel could additionally provide an estimate of current value and project completion dates based on the changing market conditions. This will empower proactive loan management processes. The displayed results (sometimes referred to herein as the “dashboard screen” or “dashboard”) at the single loan/property level will provide a link to the .pdf version of the appraisal for that loan.

What If? Analysis—This feature allows a user to project influences and/or stresses temporarily into the data in order to have The Sentinel respond to the impact those projections would have in the portfolio. The data influences that could be altered to support this analysis include vacancy rates, absorption rates, any of the expenses that impact the NOI (i.e. real estate taxes) and any loan parameters (i.e. equity % or lending rate) that could impact the Cap Rate.

Management Overview—As shown and described in connection with FIG. 11, this feature provides a roll-up of all loan officer statuses to a higher level. By design, a loan officer can not see another loan officer's portfolio in detail. Management can see the aggregated data institution-wide and drill down to the detail level, if desired. Management dashboards are also available to view the entire institution's real estate portfolio with value indicated along side of the loan balance and/or Sentinel-projected value. Again, drill-through capability in order to review any alert or warning notices is provided. Dashboards (displays) can be provided to show how the client institution compares to select peers (other institutions) on metrics such as, loans by category, loans versus allowances for losses, capital ratios or other published statistics.

The main thrust of the processing and service provided by the present invention is to provide lenders a legitimate value of their real estate assets on a close to a real time basis as possible. The valuation along with supporting processes will promote tighter management of their exposure in downward markets and present opportunities in rising markets, based on the underlying value of the collateral behind their real estate backed loans. This process focuses on the lenders internal data as primary source of market information. Since lenders typically lend locally, their real estate portfolio is backed in local assets. The present invention is a local market value expert and early warning system for their specific properties of interest.

The federal banking agency's Guidance on Transaction Sensitivity for CRE Lending focuses on Absorption Rates, Sales Prices, Rent Rates, Vacancy Rates, LTV Ratios, LTV Ratios and other varying market conditions which can be set as Alert Tolerances for the present invention.

The present invention allows the preparation and review of What If? Scenarios. A Loan Officer or other system user may establish a session in order to apply overrides to existing data in order to project the impact of market changes against his/her portfolio or individual properties based upon parameters established by FDIC or parameters selected by the loan officer or lending institution.

The Loan Sentinel can be instructed to recalculate projected values using client entered data and test versus the defined tolerances to see if new alerts would be triggered. The process is for the current session and can be repeated with different parameters being entered. Examples of parameters are shown in Table 1 below and include:

TABLE 1

Loan Variables
Lending Rate
LTV Ratios
Amortization Terms
Lease Properties
Absorption Rate
Rent Rates
Vacancy Rate
Rollover Risk
Reserves - Maintenance
Property if for Sale
Sales prices
Expense Charges
Taxes
Fuel
Insurance
Reserves - Maintenance
Reserves - Contingency
Absorption Rate
Rollover Risk

Loan Loss Reserves over the past years have been significant and increasing. On a $4700 million loan portfolio, 0.19% represents $1,330,000, quarterly while on an Annual basis, that is $5,320,000. The present invention when used as an early warning system facilitates driving that cost down significantly, and that is only using part of the functionality of the invention.

Accordingly, the present invention provides a number of novel features including a Database of Real Estate Portfolio Assets; Projected market values for each property, as of the previous day; Reporting by CRA Categories, Call Report Categories, Portfolio Concentrations by Use or by Geography, as of the previous day; Alerts produced based on bank set tolerances against projected values or borrower behavior, this allows the loan officer to focus his or her energy to properties/borrowers that need attention; Development properties monitored for activity and compared to expectations (Addresses FDIC concern over changing market conditions during gestation); Facility for doing stress tests to the portfolio, as defined by the FDIC; Current quantitative market data to support (and document for the FDIC) loan decision factors; and Drive down Loan Losses over time to give evidence to Supervisors that lower Reserve requirements are valid for the lender's operation.

Modifications and substitutions by one of ordinary skill in the art are considered to be within the scope of the present invention, which is not to be limited except by the following claims.

The invention claimed is:

1. A system method for like King, storing and analyzing loan data, said method comprising the acts of:
receiving data concerning a funded collateralized loan, said data including a plurality of loan data values;
storing said data concerning a funded, collateralized loan in a loan database;
accessing said stored data concerning a funded, collateralized loan and presenting at least a portion of said data concerning a funded, collateralized loan in a user defined graphical format;
receiving one or more user defined loan data value tolerance settings;
responsive to said received one or more user defined loan data value tolerance settings, automatically and periodically comparing said data stored in said loan database against said user defined loan data value tolerance settings; and
responsive to said comparing, providing an indication to a user of at least a loan or data value outside said tolerance settings.

2. The system and method of claim 1, wherein said loan collateral is real estate.

3. The system and method of claim 1, wherein said data concerning a funded collateralized loan is data from a user's organization.

4. The system and method of claim 1, wherein said data concerning a funded, collateralized loan is data external to a user's organization.

5. The system and method of claim 1, wherein said loan data values are loan specific.

6. The system and method of claim in wherein said loan data values are not loan specific.

7. The system and method of claim 1, wherein said tolerance setting is a predetermined value below which a loan data value is considered out of tolerance.

8. The system and method of claim 1, wherein said tolerance setting is a predetermined value above which a loan data value is considered out of tolerance.

9. The system and method of claim 1, wherein said tolerance setting is a predetermined range of values within which said loan data value is considered in tolerance.

10. The system and method of claim 1, wherein the act of automatically and periodically comparing said data concerning a funded, collateralized loan compares loan data value from within a user's organization with data external to a user's organization.

11. The system and method of claim 1, wherein said act of providing an indication to a user of at least a data value out of tolerance includes the act of providing an indicator to a user of a data value close to out of tolerance.

12. The system and method of claim 11, wherein said indicator is color of the data.
